(19) United States
(12) Patent Application Publication
(10) Pub. No.: US 2012/0133943 A1
(43) Pub. Date: May 31, 2012

(54) Systems And Methods For Multi-Wavelength SPR Biosensing With Reduced Chromatic Aberration

(76) Inventors: Norman Henry Fontaine, Painted Post, NY (US); Guangshan Li, Painted Post, NY (US); Anping Liu, Horseheads, NY (US); Jinlin Peng, Painted Post, NY (US)

(21) Appl. No.: 12/955,421

(22) Filed: Nov. 29, 2010

(51) Int. Cl. G01N 21/55

(52) U.S. Cl. 356/445

(57) ABSTRACT

Systems and methods for sensing a surface plasmon resonance (SPR) biosensor using two or more wavelengths and with reduced chromatic aberration are disclosed. The system includes a beam-forming optical system that has chromatic aberration at the two or more wavelengths. A light source system provides respectively light of the two or more wavelengths, with light of each wavelength provided from a different distance from the beam-forming optical system. The different distances are selected to reduce or eliminate adverse effects of chromatic aberration on the formation of a focus spot on the SPR biosensor chip. An illumination system for illuminating a SPR biosensor using different light having different wavelengths is also disclosed.

The entire disclosure of any publication or patent document mentioned herein is incorporated by reference.

### FIELD

The disclosure relates generally to biosensing, and in particular to systems and methods for performing surface-plasmon resonance (SPR) biosensing using multiple wavelengths in a manner that reduces or eliminates chromatic aberration.

### SUMMARY

The disclosure provides systems and methods for real-time SPR biosensing using multiple wavelengths in a manner that reduces or eliminates the detrimental effects of chromatic aberration typically associated with the beam-forming optical system used to focus light onto a SPR biosensor. The SPR biosensing systems and methods have variable penetration depth resolution capability. The disclosure also provides for use of the SPR biosensor systems and methods for performing chemical and biological assays and for related biosensing applications.

### BRIEF DESCRIPTION OF THE DRAWINGS

In embodiments of the disclosure:

FIG. 1 is a schematic diagram of an example multi-wavelength SPR biosensor system according to the disclosure;

FIG. 2 is a plot of the intensity of the reflected light from the SPR biosensor as a function of the incident angle of light upon the SPR biosensor, illustrating the sensitivity of the SPR resonance to the incident angle of light in the incident light beam;

FIG. 3 is a schematic illustration of an example SPR biosensor chip that constitutes part of the SPR biosensor;

FIG. 4 is a plot of the penetration depth ΔP (microns) versus the illumination wavelength (microns), illustrating the increase in penetration depth with wavelength for an example SPR biosensor similar to that shown in FIG. 3 and having a 50 nm thick gold metal layer;

FIGS. 5A through 5C are computer simulations of example rectangular focus spots formed at a SPR biosensor chip of a SPR biosensor for light of wavelengths 650 nm, 980 nm and 1480 nm, respectively, using a prior art multi-wavelength SPR biosensor system that does not correct for chromatic aberration in the beam-forming optical system;

FIG. 6 and FIG. 7 are top and side views of an example multi-wavelength SPR biosensor system configured to compensate for the adverse affects of chromatic aberration on the focus spots formed on the SPR biosensor chip over a relatively wide range of wavelengths;

FIG. 8 and FIG. 9 are end-on and a top-down views, respectively, of an example V-groove fiber support member that supports a plurality of optical fibers as part of the light source system so that the optical fiber ends are arranged in a staggered configuration relative to the beam-forming optical system;

FIG. 10 is a schematic diagram of an example light source system that includes n light-emitting devices respectively optically coupled to n optical fibers, where the light sources are electronically switched by a programmable switch;

FIG. 11 is a schematic diagram of an example light source system that includes n light-emitting devices connected to the input side of an optical switch via n optical fibers, with the output side of the optical switch having n optical fibers;

FIGS. 12A through 12C are similar to FIGS. 5A through 5C, except that the light source system was configured according to the present disclosure to compensate for the adverse effects of chromatic aberration in the beam-forming optical system;

FIG. 13 illustrates an example photodetector array image of the SPR angular response from two sample regions and at one wavelength (660 nm) with two regions of interest shown, one for each sample region;

FIG. 14 is a plot of the SPR biosensor reflectivity versus the angle (degrees) of light in the incident light beam as calculated for wavelengths of 650 nm (circles), 980 nm (squares) and 1480 nm (solid line);

FIG. 15 is a schematic diagram of an example of light source system that utilizes light-emitting devices that emit light of different wavelengths into free-space and that combines the different light onto a common optical path using dichroic mirrors; and

FIG. 16 is similar to FIG. 15 and illustrates an example light source system that includes a single broad-band, axially translatable light-emitting device.

### DETAILED DESCRIPTION

Various embodiments of the disclosure are described in detail below with reference to the drawings. Reference to various embodiments does not limit the scope of the disclosure, which is limited only by the scope of the attached claims. Additionally, any examples set forth in this specification are not limiting and merely set forth some of the many possible embodiments for the claimed invention.

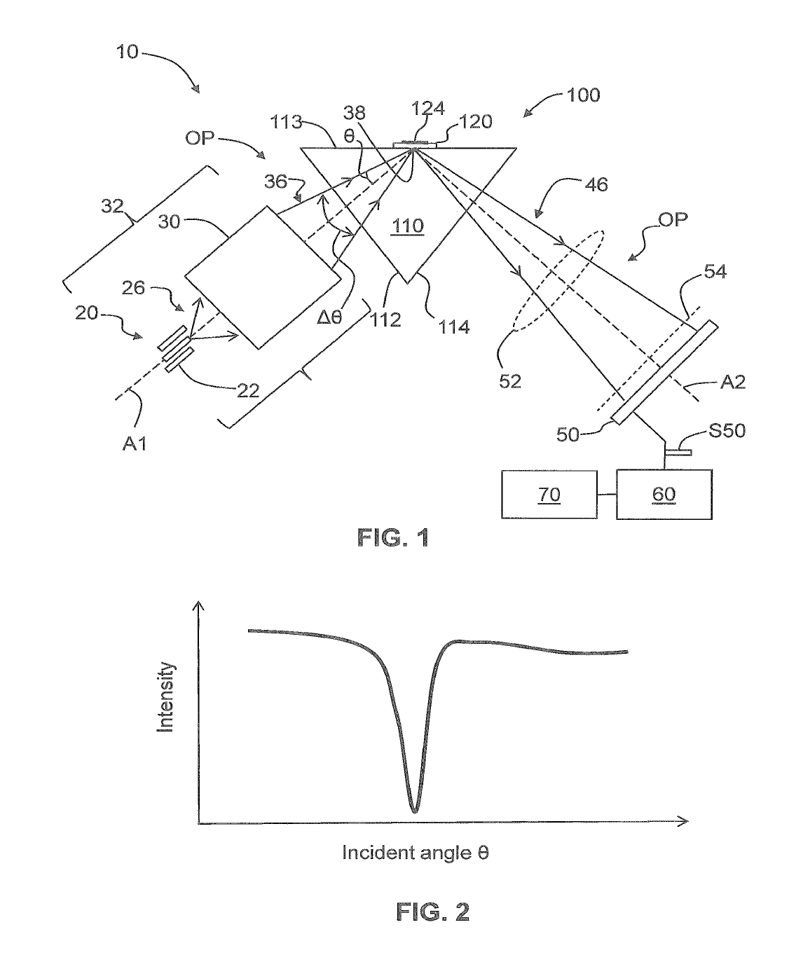

FIG. 1 is a schematic diagram of an example multi-wavelength SPR biosensing system 10 according to the disclosure. System 10 includes first and second axes A1 and A2 that intersect and that generally define a main optical path OP through the system. System 10 includes along axis A1 a multi-wavelength light source system 20 and a beam-forming optical system 30. Light source system 20 and beam-forming optical system 30 constitute an illumination optical system 32. Light source system 20 generates initial light beams 26 each having a different wavelength. This includes, for example, generating light beams 26 having different center wavelengths and different associated spectral bands. System 10 also includes a SPR biosensor 100 generally arranged at the intersection of axes A1 and A2. A photodetector array 50 is arranged along axis A2. An example photodetector array 50 includes a CCD camera.

In an example, an optional collection optical system 52 (shown in phantom) is arranged between SPR biosensor 100 and photodetector array 50, and is used to collect reflected light 46 from the SPR biosensor and image it onto the photodetector array. Also, in an example, a translucent screen 54 (dashed line) can be placed in front photodetector array 50 so that reflected light 46 from biosensor 100 forms an image on the screen, and photodetector array 50 includes a CCD camera that can view (detect) the image. A data acquisition unit 60 is operably connected to photodetector array 50. An example data acquisition unit 60 is or includes a computer configured to perform signal processing. A display 70 may be operably connected to data acquisition unit 70.

System 10 is a representative system for illustrating the general principles of the disclosure. Other variations of system 10, such as those discussed below, can incorporate, for example, the addition of fiber or free-space couplers, fiber arrays, arrayed optics, beam splitters, or combination thereof, to enable multiple light sources, multiple photodetectors, and the like into the system.

In an example, multi-wavelength light source system 20 generates p-polarized light beams 26 that travel along axis A1. Light source system 20 can comprise, for example, one or more light-emitting devices 22 operating at different wavelengths that range from visible to near-IR wavelengths, for example, from about 400 nm to about 1,700 nm. Light-emitting devices 22 can also have wavelengths (or spectral bandwidths) across a large range (e.g., 400 to 1,700 nm). Light source system 20 can be configured to sequentially operate light-emitting devices 22 to sequentially generate light beams 26 having the different wavelengths. Light source system 20 can also be configured to simultaneously operate light-emitting devices 22 so that a given light beam 26 has two or more wavelengths at a given time. Examples of these capabilities for light source system 20 are discussed in greater detail below.

Many different types of light-emitting devices 22 with a variety of spectral properties can be used, such as lasers, laser diodes, light emitting diodes (LED), superluminescent diodes (SLD), white light sources, super-continuum light sources, or combinations thereof. In an example, light beams 26 emanating from one or more of light-emitting devices 22 can be delivered to a beam shaper (not shown) having, for example, free-space optics in which optical mirrors, lenses or combinations thereof are used. Light beams 26 can also be delivered, for example, with optical fibers or a fiber bundle. The optical fibers can be single mode, multimode, or a combination thereof, and can polarization-maintaining when the light-emitting devices 22 generate linearly polarized light.

The different wavelengths for light beams 26 can be achieved using, for example, wavelength multiplexing techniques that combine light from multiple light-emitting devices 22 into one fiber or one light beam to simplify the optical configuration for system 10. In this type of configuration, the biosensor measurement is performed at each wavelength. That is, system 10 only measures one data point (i.e., the SPR response) at a given point in time and at a given wavelength and thus at a given penetration depth. For the next measurement, the wavelength is changed to provide a different penetration depth. Changing the wavelength can be accomplished in any number of ways known in the art, including using optical switching techniques, such as flipping mirrors, galvanometers, fiber-optic switches, beam blocking switches, translatable apertures, and like means and methods, or a combination thereof.

When the light-emitting devices 22 are combined by wavelength multiplexing techniques, the wavelength selection can be achieved by, for example, turning on each light-emitting device 22 using one or a series of optical switches. To adequately detect biological events using the multi-wavelength techniques disclosed herein, it is particularly advantageous to switch between light-emitting devices 22 through the range of available wavelengths at a rate faster than the rate at which those biological or biochemical events occur at the sample. Examples of light source system 20 with such wavelength-switching capability are discussed below.

An example light source system 20 includes four light-emitting devices 22 in the form of four laser diodes emitting at wavelengths of 650 nm, 800 nm, 980 nm, and 1500 nm, and also includes respective single-mode optical fibers optically coupled to the light-emitting devices. An example of such a light source system 20 is discussed in greater detail below.

The specific wavelengths for light-emitting devices 22 can be selected to lie within a spectral range in which the sample absorption and scattering loss are relatively low. For samples having a strong fluorescence emission, the wavelengths may be selected to avoid the fluorescence absorption peak to minimize its impact on index of refraction sensitivity. In contrast, in a system where surface plasmons are to be used to specifically excite, for example, surface fluorescence or quantum dots, then the opposite is true, and the wavelength may be selected to lie within the excitation band of the fluor(s) or quantum dots.

With continuing reference to FIG. 1, an example SPR biosensor 100 includes a coupling prism 110 having an input surface 112, a coupling surface 113 and an output surface 114. An example coupling prism is a right-angle prism made of BK7 or SF11 glass. SPR biosensor 100 also includes a SPR biosensor chip 120 operably arranged at prism coupling surface 113. A user-provided sample 124, such as an analyte, test specimen, cell, a cell component, a cell construct, and like bio-entities, is operably arranged on SPR biosensor chip 120. SPR biosensor chip 120 is optically contacted to prism coupling surface 113 using, for example, an index-matching oil having the substantially the same refractive index as the glass substrate (discussed below) of the SPR biosensor chip, the prism, or both. In an example, the glass substrate and the prism have substantially the same refractive index.

Beam-forming optical system 30 is configured to form from each light beam 26 a corresponding incident light beam 36 having any one of a number of possible desirable beam shapes and a suitable numerical aperture, thereby providing for controlled illumination of an area of SPR biosensor 100 as defined by a focus spot (or focus image) 38. Incident light beam 36 is focused to provide a range Δθ of incident illumination angles θ at focus spot 38. As discussed below and illustrated schematically in FIG. 2, SPR biosensor 100 is sensitive to the incident angle θ at which it is irradiated, and this angular sensitivity allows for measurement of the SPR resonance.

Beam-forming optical system 30 can comprise, for example, a number of optical lenses, one or more polarizers, and a beam modulation element. Focus spot 38 can be a point, a line, a dot, an elongate spot, or have any reasonable extended shape, and the word “focus spot” is used herein as shorthand to denote all of these light image possibilities. A polarizer (or multiple polarizers) can be used in beam-forming optical system 30 to ensure that each light beam 26 is p-polarized, which polarization is in the plane of incidence of incident light beam 36. For example, consider illuminating SPR biosensor 100 with a line focus spot 38 using a light source system 20 that employs optical fibers coupled to corresponding light-emitting devices 22. The light beams 26 emanating from the optical fiber end have circular beam cross-sections need to be reshaped into rectangular or elliptical beam cross-sections. This transformation can be accomplished with beam-forming optical system 30 having, for example, a combination of cylindrical lenses and other commonly used lenses, such as spherical, aspherical lenses, anamorphic lenses, diffractive optic beam shapers, mirrors, prisms or a combination thereof. In an example embodiment, beam-forming optical system 30 is anamorphic.

Since only the p-polarization component of incident light beam 36 can couple to the SPR resonance of SPR biosensor 100, the s-polarization component is not necessary and can potentially impair the ability of system 10 to optimally detect the SPR minimum in reflected light 46. Hence, a polarizer may be needed to block any residual s-polarization component in the incident light beam 36 and allow only p-polarized light to be incident upon SPR biosensor 100. Similarly, a polarization-controlling element (e.g. such as fiber optical polarization controlling paddles) may be used to ensure light beam 26 is substantially p-polarized at sample 124. A beam-modulation element (not shown) may be necessary to overcome detrimental speckle effects when the spectral width of light beam 26 is sufficiently narrow (e.g., less than about 0.01 nm). In this instance, the beam-modulator element changes the beam location slightly (e.g., less than about 3 degrees) at a speed much faster than the data collection speed (e.g., 100 Hz) to minimize speckle and thus improve the signal-to-noise ratio.

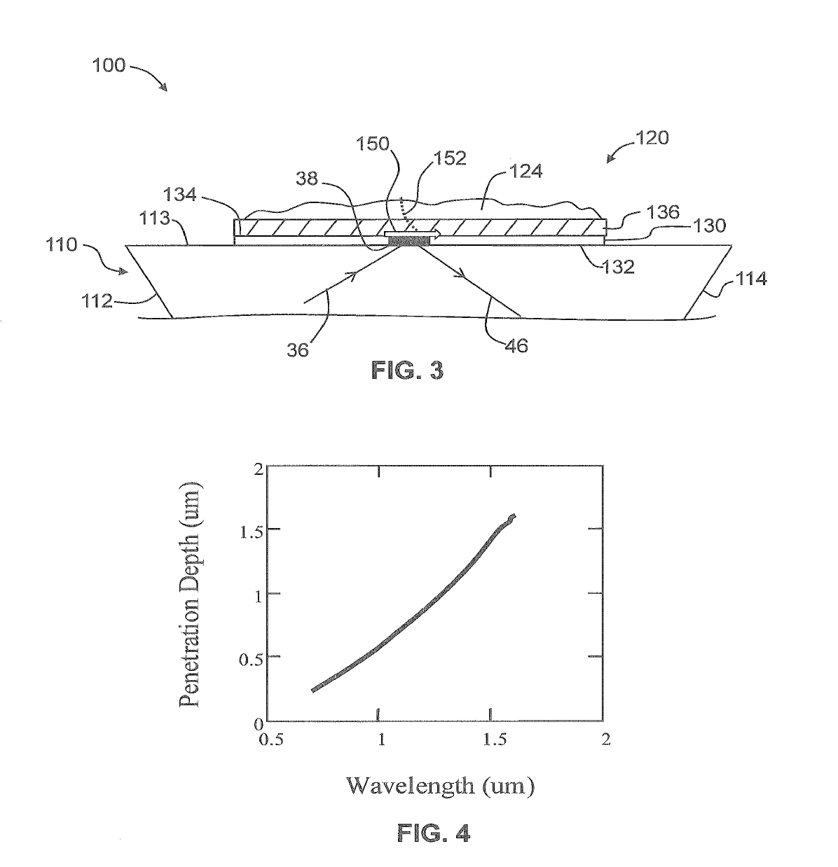

FIG. 3 is a schematic illustration of an example SPR biosensor chip 120 shown as part of SPR biosensor 100. SPR biosensor chip 120 includes a glass substrate 130 having surfaces 132 and 134. A thin metal layer (film) 136 is provided on substrate surface 134 while substrate surface 132 remains uncoated. Uncoated surface 132 interfaces with prism coupling surface 113 to form optical contact therebetween. Sample 124 is arranged on or near metal layer 136. Metal layer 136 may comprise, for example, gold, silver, combinations thereof, or other conducting materials and combinations thereof. Other SPR biosensor chip configurations may be used other than that shown in FIG. 3, such as for example the SiOG sensor chip configuration disclosed in U.S. patent application Ser. No. 12/627,515, and in U.S. Pat. Nos. 7,176,528, 7,192,844, and 7,399,681.

In the general operation of system 10, light beam 26 from light source system 20 is received by beam-forming optical system 30 which, as discussed above, forms therefrom the corresponding incident light beam 36. Incident light beam 36 travels through prism input surface 112 and through coupling surface 113 and forms focus spot 38 at the location where SPR biosensor chip 120 resides. In particular, focus spot 138 is formed substantially at the interface surface 134 between glass substrate 130 and metal layer 136. A portion of incident light beam 36 is strongly reflected from SPR biosensor chip 120 and forms reflected light 46. Reflected light 46 travels back through prism coupling surface 113, through prism output surface 114 and then propagates to photodetector array 50. Photodetector array 50 detects reflected light 46 and converts the reflected light into electronic signals S50 that are received and processed by data acquisition unit 60. Measurement results can be displayed on optional display 70.

The light incident on SPR biosensor 120 in incident light beam 36 excites a surface plasmon wave 150 in metal layer 136 of SPR biosensor chip 120. Surface plasmon wave 150 has an attendant SPR evanescent field 152 that penetrates into sample 124 to a penetration depth ΔP. The penetration depth is defined as where the SPR evanescent field intensity drops to 1/e (i.e., about 37%) as compared to its intensity at the interface of metal layer 136 and sample 124. The penetration depth ΔP is on the order of 0.25× to 1.5× the resonant wavelength, and depends on the wavelength of light used and the particular biosensor configuration. In an example, system 10 provides a penetration depth ΔP in sample 124 in a range from about 200 nm to about 1,500 nm.

Under static conditions and at a given wavelength, the penetration depth ΔP is fixed. As surface plasmon wave 150 propagates along metal layer 136, its power is attenuated through Ohmic losses, thereby removing optical power from incident light beam 36. The portion of incident light beam 36 that does not couple to the plasmon wave resonance is reflected strongly and forms the aforementioned reflected light beam 46. This resonant absorption leads to a reflection minimum that identifies the SPR minimum reflection angle. The angle at which the intensity of reflected light 46 is at a minimum is influenced by the properties of sample 124. Shifts in the SPR minimum reflection angle can be measured with photodetector array 50. Near-surface biological and biochemical-related events occurring in sample 124 can be monitored and measured by tracking the changes in the SPR minimum reflection angle, which correspond to changes in the location of the minimum intensity of reflected light 46 detected at photodetector array 50.

The penetration depth ΔP of SPR evanescent field 152 into sample 124 is a function of wavelength. FIG. 4 is a plot of the penetration depth ΔP (microns) versus wavelength (microns) for an example SPR biosensor chip 120 having 50 nm of deposited gold as the metal layer 136. As can be seen from the plot, the longer the wavelength, the greater the penetration depth ΔP. For example, the penetration depth can be increased by about a factor of 5× using a wavelength of 1.5 microns as compared to using a wavelength of 760 nm.

For surface chemistry binding sensing applications, sample 124 has a binding volume that experiences a binding-related index of refraction change, but the biding volume thickness (binding thickness) is generally much less than the penetration depth. While there may a bulk index change in sample 124, the sample generally undergoes a rapid step-index change, which can be normalized out by simple subtraction. In this surface binding case, the penetration depth does not influence the SPR binding response and any SPR instrument with a fixed penetration depth that well exceeds the binding thickness will work. In contrast, for samples 124 that have binding and mass transport events that occur within a thickness on the order of or greater than the penetration depth, a fixed penetration depth may not be able to measure the different SPR responses throughout the sample binding volume. For example, sensing applications on biological cells would be advantaged if the cellular responses could be continuously monitored at different depths, because the biological processes could be monitored simultaneously near and between the cell membrane, the intracellular matrix, and even at the nucleus.

Hence, a configuration for system 10 that allows for sampling at multiple penetration depths would be highly desirable. This can be accomplished using multiple wavelengths for light beam 26 to provide variable detection depths (i.e., penetration depths) so that the sample refractive indices at different depths can be monitored. This information can then be compared against parameterized simulations of biological responses. The fitting parameters can then be used to characterize and quantify biological events, biochemical events, or both, throughout an extended volume of the sample. Thus, collecting SPR responses at different wavelengths and at different times allows for measuring the dynamic SPR response at different depths in the sample.

In any multi-wavelength system 10, it is highly desirable to use the same optical components and substantially the same optical path OP for multi-wavelength operation. However, it is well know by those skilled in the art that chromatic aberration in refractive beam-forming optical systems 30 can become problematic when the wavelengths are many nanometers apart (typically 100 nm and more). Chromatic aberration has the undesirable effect of shifting the image plane of beam-forming optical system 30 to different locations along axis A1 for different wavelengths. Hence, when using a simple beam-forming optical system 30, if multiple and chromatically well-separated wavelengths emanate from a single location, only one of those well-separated wavelengths can be optimally focused onto SPR biosensor chip 120. The other wavelengths will be out of focus because their image planes will lie slightly in front of or slightly behind the best-focus location on SPR biosensor chip 120.

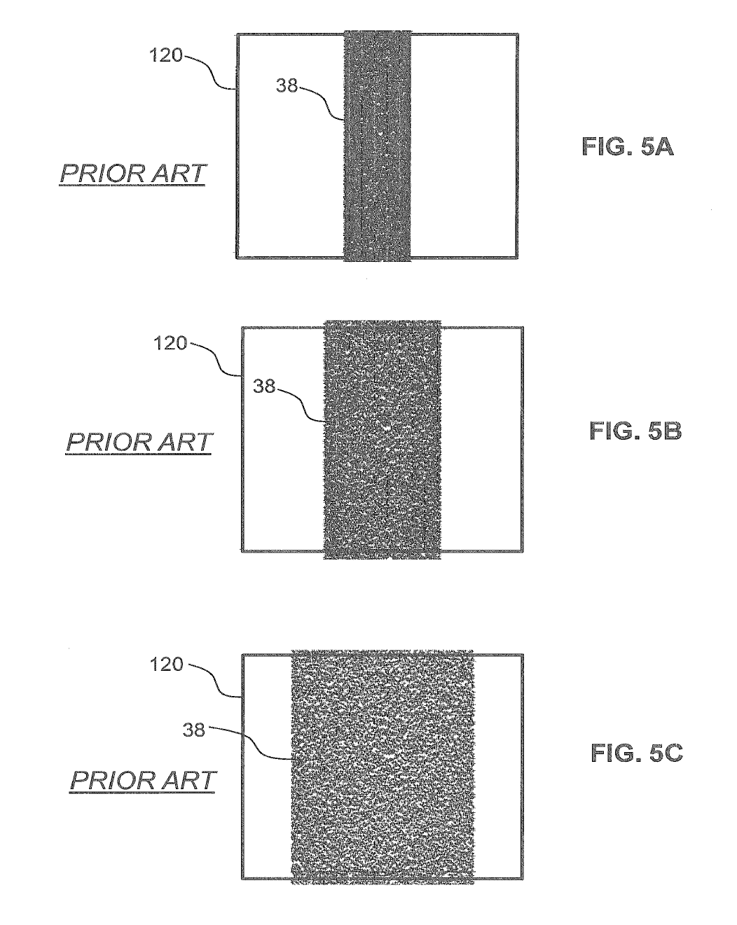

The detrimental effect of the change in the size and location of focus spot 38 with wavelength due to chromatic aberration in beam-forming optical system 30 is illustrated in FIG. 5A through FIG. 5C, which show computer simulations of example rectangular focus spots 38 associated with wavelengths of 650 nm, 980 nm and 1480 nm, respectively. In the simulations, light beams 26 were made to emanate from the same axial position and were then imaged onto SPR biosensor chip 120 by an example dioptric beam-forming optical system 30. The focus spots 38 in FIG. 5A through FIG. 5C have substantially different widths on SPR biosensor chip 120. Focus spots 38 actually extend far beyond the sample edge in the vertical direction and are shown truncated for ease of illustration.

The different focus spot widths are a result of defocus caused by the chromatic aberration in beam-forming optical system 30. The focus spots 38 for the different wavelengths target significantly different areas of SPR biosensor chip 120, which would in turn make the interpretation of SPR response data from studies of complicated specimens (e.g. cell assays) questionable, if not impossible.

The use of multi-element achromatic lenses in beam-forming optical system 30 can mitigate the adverse effects chromatic aberration to some degree and can extend the spectral band over which the focus spot 38 is well-focused on sample 124 by up to 250 nm to 300 nm. A two element achromatic lens, for example, can form substantially identical focus spots 38 on SPR biosensor chip 120, with focus spots associated with other wavelengths being slightly out of focus and thus having a different but still acceptable size. However, outside of this 250 nm to 300 nm spectral band, the chromatic aberration again becomes significant so that these focus spots 38 will have a substantially different size at SPR biosensor chip 120.

System 10 of the present disclosure is configured to utilize a very broad range of wavelengths and a simple beam-forming optical system 30, e.g., one that employs as few as two refractive lens elements. This is achieved by configuring the light source system 20 so that light beams 26 for the different wavelengths originate at different axial locations (i.e., object planes) selected to compensate for (i.e., reduce or eliminate) chromatic aberration in beam-forming optical system 30. This approach allows focus spots 38 with different wavelengths to have substantially the same spot size, shape and image location on SPR biosensor chip 120. When coupled with wavelength selection control capability, system 10 is able to detect SPR responses from substantially the same region on sample 124 over an extended range of penetration depths ΔP within a given sample and to monitor the responses in real time. As a result, system 10 can be made compact and inexpensive and can be used to provide a broad range of penetration depths for biological/biochemical assays and fundamental research.

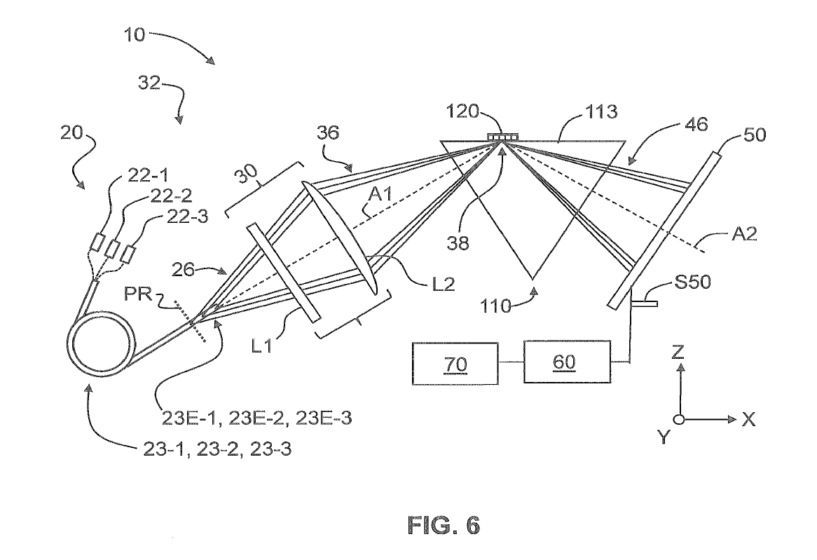

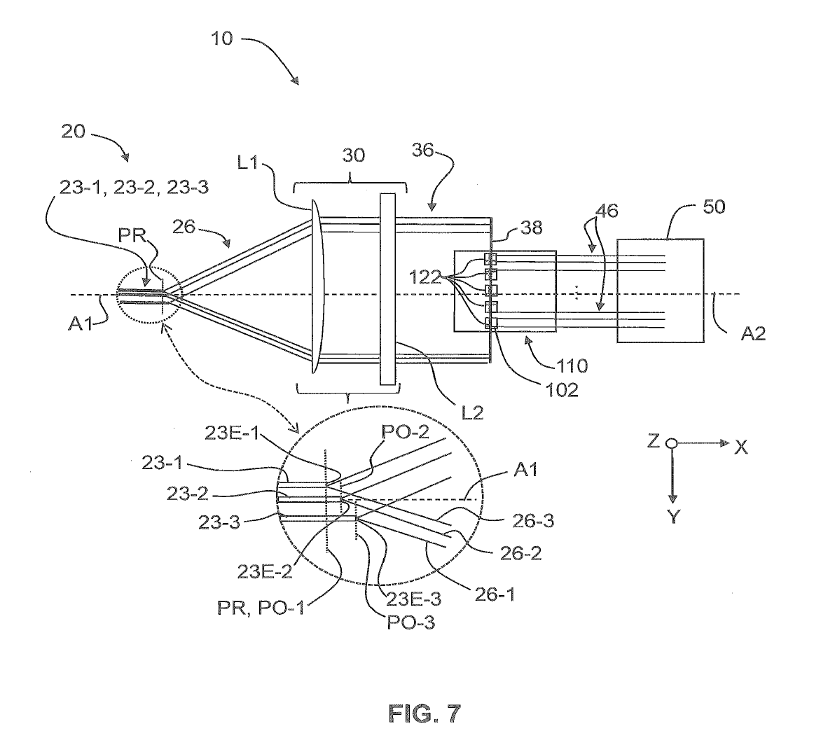

FIG. 6 and FIG. 7 are top and side views of an example system 10, with Cartesian coordinates shown for reference. The example light source system 20 includes multiple (i.e., two or more) light-emitting devices 22, with three light-emitting devices 22-1, 22-2 and 22-3 shown by way of example. Light-emitting devices 22-1, 22-2 and 22-3 are respectively optically coupled to optical fibers 23, namely 23-1, 23-2 and 23-3. These fibers have respective ends (facets) 23E, namely 23E-1, 23E-2 and 23E-3, from which respectively emanates light beams 26-1, 26-2 and 26-3 of different wavelengths λ₁, λ₂ and λ₃. Optical fiber ends 23E-1, 23E-2 and 23E-3 are arranged at different axial distances from beam-forming optical system 30. A reference plane PR at optical fiber end 23E-1 defines an object plane PO-1 with a particular axial distance reference location relative to beam-forming optical system 30. The other fiber ends 23E-2 and 23-E3 have their own corresponding object planes, namely PO-2 and PO-3.

Optical fiber ends 23E-1, 23E-2 and 23E-3 need not all lay along the optical axis A1, and in the embodiment shown two of the optical fiber ends 23E-1 and 23E-3 are laterally displaced from axis A1, thereby forming a staggered object plane configuration for the optical fiber ends. In this configuration, the axial displacement is in the direction of axis A1 and is not necessarily directly along (i.e., co-axial with) axis A1. However, light beams 26 emanating from such optical fiber ends 23E are still considered to be directed along axis A1 even if the light beams are slightly displaced therefrom.

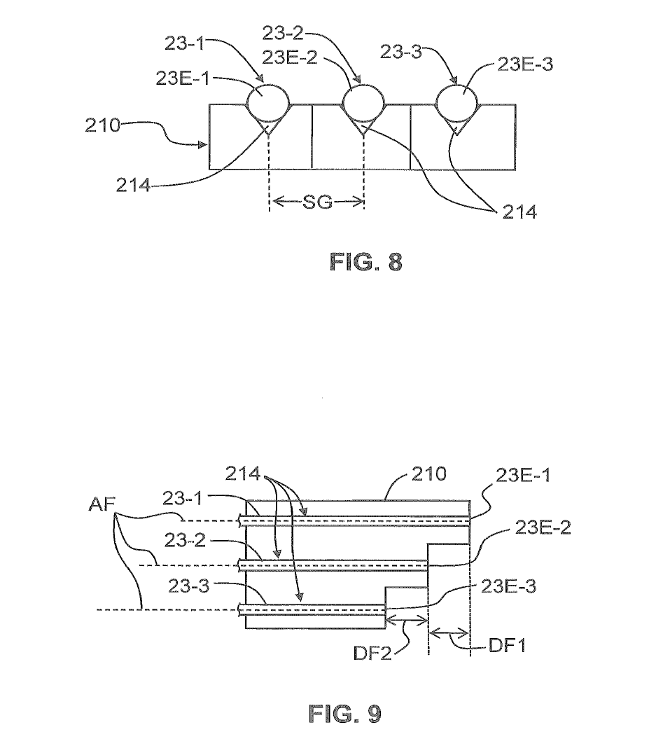

In an example, light-emitting devices 22-1, 22-2 and 22-3 operate at 650 nm, 980 nm, and 1480 nm, and optical fibers 23-1, 23-2 and 23-3 are selected so that they respectively optimally transmit light at or near these wavelengths. In an example illustrated in FIGS. 8 and 9, optical fibers 23-1, 23-2 and 23-3 are supported by a V-groove support member 210 having grooves (e.g., V-grooves) 214 with a center-to-center groove spacing SG of, for example 500 microns, which in one example is about four times the optical fiber diameter. V-groove support member 210 is configured to provide the aforementioned staggered configuration for optical fiber ends 23E.

In an example, optical fiber ends 23E are perpendicular to their respective fiber axes AF (FIG. 9). This can be accomplished with modern fiber cleaving equipment. Optical fiber ends 23E have associated optical fiber offset distances DF (shown as offset distances DF1 and DF2 in FIG. 9) that are designed to achieve substantially the same size and location for focus spot size 38 on SPR biosensor chip 120. Each of the offset distances DF is selected to substantially offset the chromatic aberration associated with beam-forming optical system 30 at the corresponding wavelengths of light beam 26 emitted by optical fibers 23. Offset distances DF need not be the same.

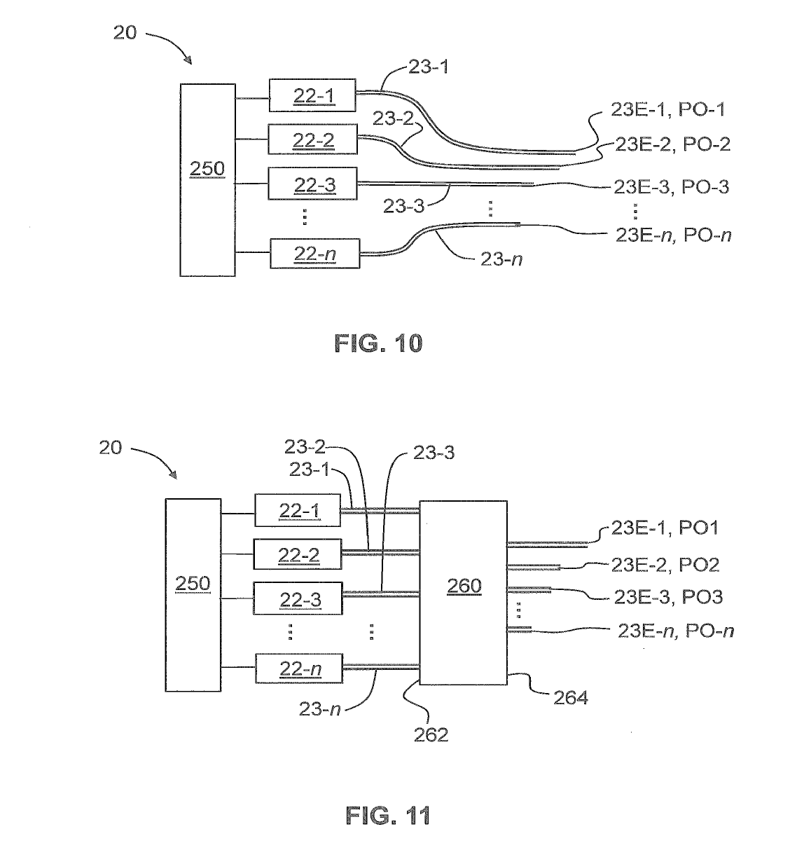

FIG. 10 is a schematic diagram of an example light source system 20 that includes n light-emitting devices 22, i.e., light-emitting devices 22-1 through 22-n, which are respectively optically coupled to n optical fibers 23, i.e., optical fibers 23-1 through 23-n. Light emitting devices 22-1 through 22-n are electrically connected to a programmable switch 250 configured to control the activation and de-activation of the light-emitting devices 22-1 through 22-n in a select manner, i.e., a select sequence. The select sequence may include simultaneous activation of some or all of light-emitting devices 22, or activating only one light-emitting device at a time.

FIG. 11 is a schematic diagram of another example light source system 20 that includes an optical switch 260 having an input side 262 and an output side 264. The example of FIG. 11 is just one representative example of the many possible examples that can enable optical switching of light beams 26 from each light-emitting device 22 to its respective output fiber. Optical fibers 23 are connected to input and output sides of the optical switch. In a configuration where programmable switch 250 can activate all light-emitting devices independently of one another, optics switch 260 is unnecessary. Alternatively, all light-emitting devices 22 can be powered (activated) simultaneously and optics switch 260 can be programmed to direct light from one or more given light-emitting devices 22 to one or more of the optical fibers 23 at optical switch output side 264. One or more independent optical switches 260 can be substituted for the single switch 260 to create a number of different optical switching configurations for light source system 20.

Thus, in an example, programmable switch 250, one or more optical switches 260, or a combination thereof, can be configured to sequentially generate light beams 26 of different wavelengths in a time series, allowing for system 10 to capture a SPR response image in photodetector array 50 for each wavelength used. In one mode of operation, light source system 20 cycles through its switching program repeatedly during a measurement. In an example, for system 10 to achieve a wide range of penetration depths ΔP, e.g., from about 200 nm to about 1,500 nm, light-emitting devices 22 can be chosen to operate at different wavelengths ranging from about 600 nm to about 1,500 nm.

With reference again to FIGS. 6 and 7, beam-forming optical system 30 includes (and further in an example, consists of) two orthogonally oriented cylindrical lenses L1 and L2 arranged along axis A1. Such a simple configuration provides advantages in terms of cost, build complexity, ghost reflection minimization and maintenance against surface contamination by dust and debris. In another example embodiment, beam-forming optical system 30 includes (and in a further example consists of) two anamorphic lenses.

Cylindrical lens L1 received light beam 26 and forms therefrom a collimated incident light beam 36 along the Y-direction. The staggered offset arrangement of fiber ends 23E thus creates multiple Y-direction collimated incident light beams 36 when the multiple light-emitting devices 22 of varying wavelengths are activated. Second cylindrical lens L2 focuses each incident light beam 36 to corresponding line type focus spots 38 that are perpendicular to the X-Z plane at the location of sample(s) 124 on SPR biosensor chip 120. By a suitable choice of cylindrical optics L1 and L2, line-type focus spots 38 can be made to have a large aspect ratio, e.g., with a narrow dimension (image width) of 3 microns to about 300 microns, and a long dimension (collimated length) of between 3 millimeters and about 100 millimeters.

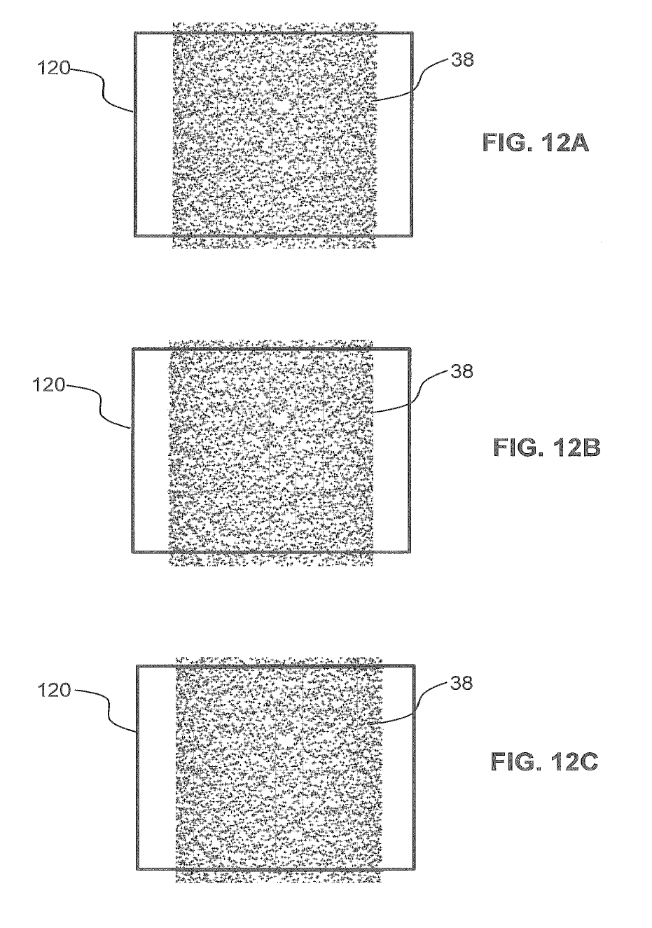

FIGS. 12A through 12C are similar to FIGS. 5A through 5C, except that the light source system was configured according to the present disclosure to compensate for the adverse effects of chromatic aberration in the beam-forming optical system. In particular, light source system 20 was configured so that light beams 26 emanate from different axial distances (object planes) for each of the different wavelengths used. The relative distances from the first surface of cylindrical lens L1 to the respective optical fiber ends 23E were 35 mm for light beam 26 of wavelength 650 nm, 41 mm for light beam 26 of 980 nm and 50.5 nm for light beam 26 of 1480 nm. This translates into offset distances of DF1=6 mm and DF2=9.5 mm. Note that the relative widths and locations of focus spots 38 for the different wavelengths are substantially the same in FIGS. 12A through 12C, in contrast to the focus spots shown in FIGS. 5A through 5C. As in FIGS. 5A through 5C, in FIGS. 12A through 12C, the line-type focus spots 38 actually extend far beyond the sample edge in the vertical direction and are shown truncated for ease of illustration.

In one example of performing SPR biosensor measurements with system 10, light source 20 sequentially provides light beams 26 of different wavelengths (or different spectral bands), e.g., through the programmable operation of light source system 20 and corresponding optical fibers 23, as discussed above. In this operational mode, one wavelength (or narrow spectral band) illuminates SPR biosensor chip 120 at a time. An example switching time for transitioning between different light beams 26 is 1 ms to 200 ms, which is much shorter than many biological or biochemical response times of interest, which typically occur in a few seconds, minutes or even hours. In an example, each light-emitting device 22 is left in the “on” state during each signal integration time at photodetector array 50. An example signal integration time is approximately 1 second.

With reference again to FIG. 7, incident light beam 36 is shaped by cylindrical lenses L1 and L2 and is focused as an elongate focus spot 38, and in an example stretches across a linear array of sensing regions 122 on the SPR biosensor chip 120. An example size for an elongate focus spot 38 is about 200 microns by 100 mm in the focused (short) and collimated (long) directions, respectively. In an example, each sensing region 122 is formed across a row of wells on the bottom of a microplate (not shown) having one or a number of wells per row (e.g., 1 to 16), with the sensing regions within each well having lengths that span across the entire well in one direction (Y-direction) and across a width of 200 microns in the other direction (X-direction). Individual assays are conducted in each well with the addition of compounds using standard assaying techniques. The microplate format could be any standard type (e.g. 96 and 384) or a non-standard type.

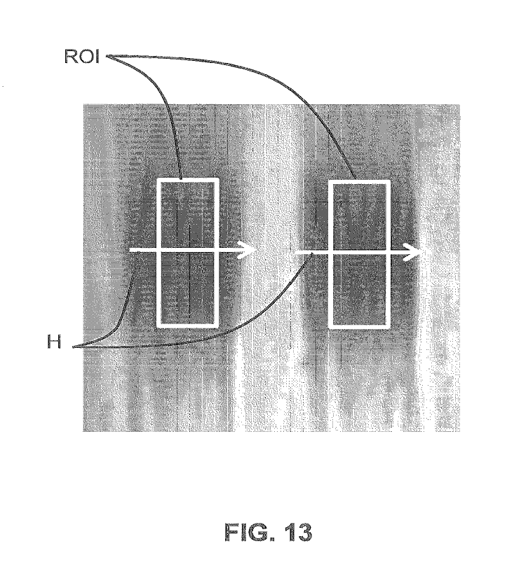

In an example, regions of interests (ROIs) can be selected from a CCD camera image (e.g., using software) at the start of an experiment to form SPR angular response lanes, one per SPR biosensor 120. One can also select more than one ROI lane per SPR biosensor 120 if multiple sensing areas are desired in each biosensing well. FIG. 13 illustrates an example photodetector array image taken while illuminating the array of samples using one wavelength (660 nm), with two ROIs identified each in separate wells. The sub-image within each ROI can be integrated in the direction perpendicular to the angular SPR response direction, which improves statistical averaging. The white arrows H in FIG. 13 show the integration direction.

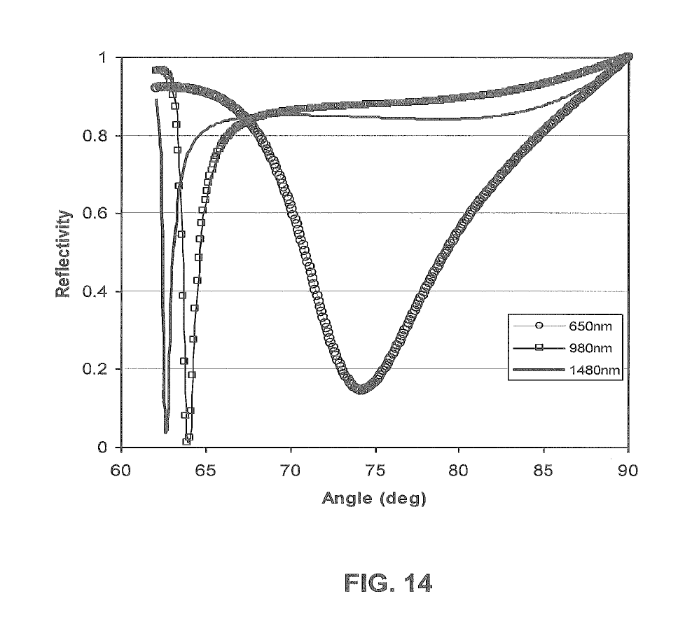

FIG. 14 is a plot of the SPR biosensor reflectivity versus incident angle (degrees) as calculated for different wavelengths. The reflectivity profiles were generated by summing up the reflected intensities across the horizontal direction (see arrow H in FIG. 13) within a given ROI. The angular differences of the SPR minimum reflection angle for the wavelengths 650 nm, 980 nm and 1480 nm are in the range of 10 degrees to 15 degrees. While these angular differences may seem large, system 10 is capable of observing such a large angular variation in SPR response. This is because incident light beam 36 has a high numerical aperture, i.e., a wide range of incident angles θ, which is needed to accomplish sampling all three wavelengths when beam-forming optical system 30 is strictly passive (i.e., has no moving parts). Incident angles as high as θ=30 degrees can be used for many applications, and even higher incident angles such as θ=45 degrees or more can be used when an even larger range of wavelengths is needed.

With reference again to FIG. 9, in an example embodiment, grooves 214 of optical fiber support member 210 are made non-parallel. This non-parallel groove configuration, combined with the staggered groove ends associated with the staggered fiber ends 23E (object planes) allow for orienting the fiber ends to locate to any point in 3-dimensional space and point in any direction, as long as they do not overlap. This configuration allows the central angle of incidence for each incident light beam 36 to be better centered on that wavelength's nominal SPR location. This is possible because respective optical fibers 23 output light beams 26 of different wavelengths.

By tracking each SPR minimum reflection angle via the corresponding location of the intensity minimum in the far-field using photodetector array 50, the effective refractive index of one or more samples 124 can be monitored for changes. For biological samples 124, such as cells and bacteria, the change in refractive index that causes the SPR response is an indication of some biological response that originates from within the volume between the sensor-sample surface and the penetration depth ΔP into the sample. For biochemical samples, the change may reflect specific chemical reactions. These might be occurring very close to the sensor surface and hence seen by all the wavelengths. On the other hand, they may occur farther from the surface and hence seen only by the wavelengths having a greater penetration depth. In this manner, system 10 is able to depth-resolve responses from extended samples in real-time.

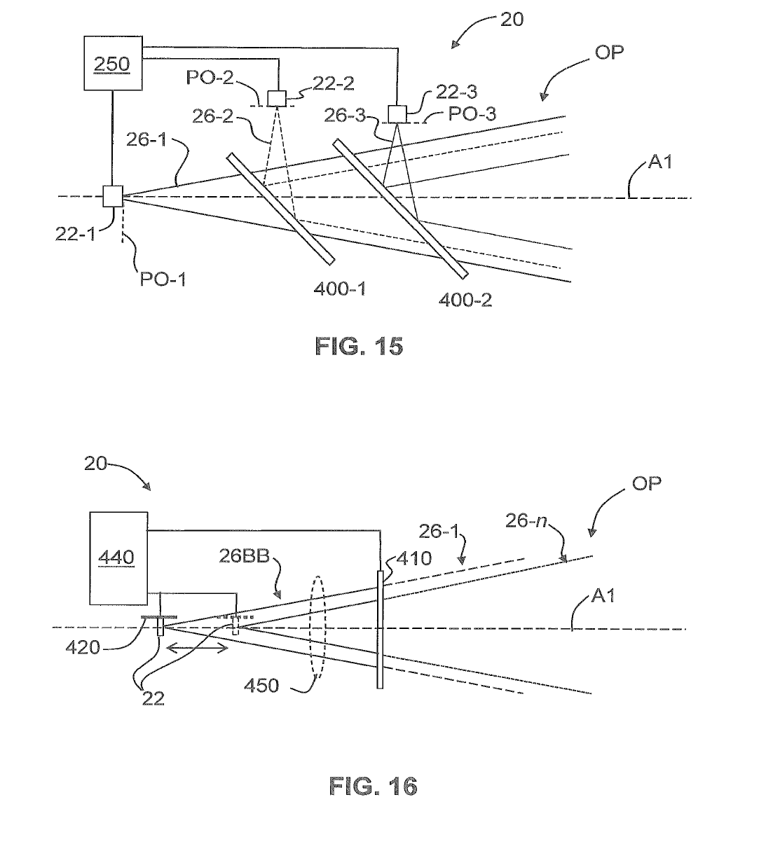

FIG. 15 is a schematic diagram of an example light source system 20 that utilizes light-emitting devices that emit light beams 26 into free-space. Dichroic mirrors 400 configured to transmit one wavelength band and reflect one or more wavelength bands are used to direct each light beam 26 along axis A1 to beam-forming optical system 30. In an example, portions of a multi-element beam-forming optical system 30 are designed to process or follow each respective dichroic mirror 400 such that some lenses of the beam-forming optical system may be common to all light beams 26, and other lenses within the beam-forming optical system would be unique to each particular light beam 26. In other words, the dichroic mirrors 400 may be incorporated within beam-forming optical system 30. Assuming light-emitting devices 22-1, 22-2 and 22-3 emit light beams 26-1, 26-2 and 26-3 of wavelengths λ₁, λ₂ and λ₃ respectively, then dichroic mirror 400-1 has a high transmission at λ₁ and high reflectivity at λ₂. Similarly, dichroic mirror 400-2 has high transmission at both λ₁ and λ₂ and high reflectivity at λ₃. As a result, light beams 26 from the respective light-emitting devices 22 are combined onto common optical path OP downstream of dichroic mirrors 400-1 and 400-2. This configuration can be expanded to accommodate more than just three light-emitting devices 22 having three different wavelengths.

The combined incident light beam 136 can then be reshaped with beam-forming optical system 30 to illuminate the SPR chip sensing regions with substantially the same illumination area and with substantially the same resultant SPR signals. In this condition, the distances between light-emitting devices 22 and incident beam-forming optical system 30 are selected to compensate for the aforementioned chromatic aberration associated with the incident beam-forming optical system.

FIG. 16 illustrates another example of light source system 20 that utilizes a single, axially translatable and relatively broad-band light-emitting device 22. In an example, light-emitting device 22 of FIG. 16 is operable to generate wavelengths over a spectral band from 400 nm to about 1600 nm. The wavelength used for SPR illumination is selected by a wavelength filter 410 arranged along axis A1 and downstream of the single light-emitting device 22. The single light-emitting device 22 generates a broad-band light beam 26BB that then passes through wavelength filter 410 to form light beam 26 having a narrow spectral band. This narrow-band light beam 26 is then used by incident beam-forming optical system 30 to form incident light beam 36.

When a tunable wavelength filter 410 is used, the wavelength of illumination can be varied and thus leads to variable penetration depths. In an example embodiment, tunable wavelength filter 410 is configured (e.g., via select optical coatings) so that its filter band can be tuned by changing its angle relative to axis A1. In an example where the filtering properties of tunable wavelength filter are sensitive to the incident angle of light thereon, light beam 26 is made substantially collimated prior to being incident upon tunable wavelength filter 410. This can be accomplished using, for example, a collimating optical system 450 (shown in phantom) between broad-band light-emitting device 22BB and tunable wavelength filter 410. In an example, collimating optical system 450 and tunable wavelength filter 410 can be considered part of beam-forming optical system 30.

To compensate for chromatic aberrations, the distance between the single light-emitting device 22 and incident beam-forming optical system 30 is axially adjusted as the wavelength of light beam 26 is changed via filtering, e.g., from λ₁ to λₙ, associated with light beams 26-1 and 26-n, respectively. This is accomplished, for example, by mounting light-emitting device 22 on a traveling stage 420. In an example, traveling stage 420 and light-emitting device 22 are controlled by a controller 440, with the controller synchronizing the light-emitting device activation with its location relative to tunable filter 410, and also optionally controlling tunable wavelength filter 410. Thus, at a given wavelength, a given object plane (e.g., fiber end 23E) is located at the proper location so that focus spot 38 from one object plane PO comes to a proper focus (image plane) onto the same sample region as the focus spot associated with other object planes PO.

An alternative embodiment replaces the broadband light-emitting device 22 with numerous narrow-band light-emitting devices 22 and incorporates a number of optical switches, which may be of a fiber optic or free-space design. Then, as each wavelength is switched, the object plane PO is moved to the proper object location prior to acquiring data for that particular wavelength.

System 10 has a number of advantages, including that it can have a small form factor that can be used to eliminate unnecessary chamber temperature control components and thus reduces instrument costs. Also, unlike conventional SPR configurations where the optical elements have to be designed for specific wavelengths to correct chromatic aberrations, the systems and methods described herein can be applied to any wavelength range to enable multiple penetration depths. No special optical glass, reflection coatings or lens designs are needed to correct a wide range of chromatically induced aberrations.

The disclosure has been described with reference to various specific embodiments and techniques. However, it should be understood that many variations and modifications are possible while remaining within the scope of the disclosure.

What is claimed is:

1. A system for sensing a surface plasmon resonance (SPR) biosensor using two or more wavelengths, comprising:
a beam-forming optical system having an optical axis and chromatic aberration at the two or more wavelengths, the beam-forming optical system configured to form for each wavelength an incident light beam that forms a focus spot at the SPR biosensor, with a portion of each incident light beam reflecting from the SPR biosensor to form a corresponding reflected light beam that contains SPR signals;
a light source system that emits light of the two or more wavelengths from respectively different distances from the beam-forming optical system, the distances selected to reduce or eliminate the chromatic aberration so that the focus spots for the two or more wavelengths have substantially the same size and location at the SPR biosensor;
a photodetector arranged to receive the reflected light beams and detect the SPR signals contained therein; and
a data acquisition unit electrically connected to the photodetector and configured to process the detected SPR signals.

2. The system of claim 1, wherein the SPR sensor comprises:
a SPR biosensor chip having a glass substrate with opposing first surface and second surface, having a metal layer formed on the first surface;
a prism having a prism surface that optically contacts the substrate second surface, with the prism and SPR biosensor chip configured to excite a surface plasmon wave in the metal layer for each incident light beam; and
a sample arranged adjacent to the metal layer.

3. The system of claim 1, further comprising the light source system having two or more optical fibers that respectively emit light beams having different wavelengths, with the optical fibers each having an end arranged at respective ones of the different distances.

4. The system of claim 1, wherein the two or more wavelengths provide a penetration depth in the sample in a range from about 200 nm to about 1,500 nm.

5. The system of claim 1, wherein the two or more wavelengths are within about 630 nm to about 1,550 nm.

6. The system of claim 1, wherein the beam-forming optical system consists of two orthogonally arranged cylindrical lenses.

7. The system of claim 1, wherein the light source system includes a plurality of light sources and at least one of a programmable electrical switch electrically connected to the light sources, or an optical switch optically connected to the light sources.

8. A method of sensing a surface plasmon resonance (SPR) biosensor that reduces or eliminates adverse focus effects of chromatic aberration, comprising:
sequentially generating, from different axial distances from a beam-forming optical system having an optical axis and chromatic aberration, respective light of different wavelengths, the different distances being selected to reduce or eliminate the chromatic aberration;
receiving the light of different wavelengths with the beam-forming optical system and sequentially forming corresponding sequential light beams having the different wavelengths and that are made incident upon the SPR biosensor;
forming from the sequential incident light beams sequential focus spots at the SPR biosensor, the focus spots having substantially the same size, shape, and location at the SPR biosensor;
reflecting a portion of each of the incident light beams from the SPR biosensor to form corresponding sequential reflected light beams that each contain SPR signals;
sequentially detecting the reflected light beams with a photodetector to detect the SPR signals contained therein; and
processing the detected SPR signals in a data acquisition unit.

9. The method of claim 8, further comprising the light of different wavelengths emanating from respective different optical fiber ends.

10. The method of claim 8, further comprising the SPR biosensor having a sample and selecting the different wavelengths to provide a penetration depth into the sample from about 200 nm to about 1,500 nm.

11. The method of claim 8, further comprising forming the SPR biosensor from a substrate having a first surface in contact with a prism and a second surface having an adjacent metal layer, the SPR biosensor configured to support a surface plasmon wave in the metal layer, and further comprising arranging a sample adjacent to the metal layer.

12. The method of claim 8, further comprising defining the different axial distances with at least one dichroic mirror.

13. The method of claim 8, further comprising sequentially generating the light of different wavelengths from two or more light-emitting devices optically coupled to at least one optical switch.

14. An illumination system for illuminating a surface plasmon resonance (SPR) biosensor with different wavelengths of light, comprising:
a beam-forming optical system having chromatic aberration at the different wavelengths of light; and
a light source system arranged relative to the beam-forming optical system and configured to provide respective light of different wavelengths to the beam-forming optical system from respective different distances from the beam-forming optical system to reduce or eliminate the chromatic aberration.

15. The illumination system according to claim 14, further comprising the light source system having at least two light-emitting devices, and at least two optical fibers respectively optically coupled to the at least two light-emitting devices, with the at least two optical fibers having respective fiber ends from which the light from the at least two light-emitting devices respectively emanates.

16. The illumination system according to claim 15, further comprising a programmable optical switch electrically connected to the at least two light-emitting devices.

17. The illumination system according to claim 15, further comprising at least one optical switch optically coupled to the at least two optical fibers.

18. The illumination system according to claim 15, further comprising at least one dichroic mirror arranged to provide light of different wavelengths along a common optical path.

19. A multi-wavelength system for performing surface plasmon resonance (SPR) sensing of a SPR biosensor, comprising:
the illumination system of claim 14 arranged to illuminate the SPR biosensor with light having different wavelengths to create corresponding reflected light beams each having a SPR signal; and
a photodetector array arranged downstream of the SPR biosensor and configured to receive and detect the reflected light beams and generate electrical signals representative of the SPR signals.

20. The system of claim 19, further comprising a data acquisition unit electrically connected to the photodetector array to process the detected SPR signals.
